(19) United States
(12) Patent Application Publication
(10) Pub. No.: US 2005/0130509 A1
(43) Pub. Date: Jun. 16, 2005

(54) Electrical terminal

(76) Inventor: XiaoGao Yang, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 11/001,872

(22) Filed: Dec. 1, 2004

(30) Foreign Application Priority Data
Dec. 16, 2003 (CN) 2003201233896

(51) Int. Cl. H01R 11/22

(52) U.S. Cl. 439/851

(57) ABSTRACT

An electrical terminal (1) is received in an insulating housing (21) of an electrical connector (2). The electrical terminal (1) includes a contacting portion (2), a soldering portion (13), a retaining portion (12) retained in the insulating housing (21) and a coupling portion (14) connecting with the contacting portion (11) and the soldering portion (13). The contacting portion (11) defines a contacting point (110) adjacent to a tip end thereof. The contacting point (110) includes an upper section (111) and a lower section (112) wider than the upper section (111). As a result, the contacting point (110) is in a form of blade.

### BACKGROUND OF THE INVENTION

1. Field of the Invention

The present invention relates to an electrical terminal, and particularly to an electrical terminal received in an insulating housing of an electrical connector, and mated with a corresponding mating electronic component electrically.

2. Description of Related Art

U.S. Pat. No. 5,484,302 discloses a card edge connector surface mounted onto a printed circuit board (PCB). The card edge connector comprises an insulating housing, a pair of latch arms extending from two ends of the insulating housing and a plurality of terminals installed in the insulating housing. An elongated slot is defined in the housing for receiving a mating portion of an electronic card. Each terminal has a contacting portion received in the slot for electrical connection with a corresponding gold finger of the mating portion of the electronic card. However, in application, the gold fingers of the electronic card tend to be stained by dielectric material. Certainly, this will adversely affect the electrical connection between the gold fingers of the electronic card and the contacting portions of the contacts.

Hence, an improved electrical terminal is required to overcome the disadvantage of the prior art.

### SUMMARY OF THE INVENTION

Accordingly, an object of the present invention is to provide an improved terminal having a contacting point that can ensure an electrical connection between the terminal and a corresponding electronic component.

In order to achieve the object set forth, an electrical terminal in accordance with the present invention is received in an insulating housing. The electrical terminal comprises a contacting portion, a soldering portion, a retaining portion retained in the insulating housing and a coupling portion connecting the contacting portion and the soldering portion. The contacting portion defines a contacting point including an upper section and a lower section. The lower section is wider than the upper section. As a result, the contacting point of the terminal is in a form of blade that can scrap stained dielectric material off a mating portion of a corresponding mating electronic component.

These and additional objects, advantages and novel features of the present invention will become more apparent after reading the following detailed description of the present embodiment with reference to the accompany drawings.

### BRIEF DESCRIPTION OF THE DRAWINGS

FIG. 1 is an elevational view of an electrical terminal in accordance with the present invention;

FIG. 2 is a partially cross-sectional, assembled view of the terminal in accordance with the present invention with an insulating housing and with an electronic component;

FIG. 3 is a partly enlarged, side elevational view of the electrical terminal taken along a direction X shown in FIG. 1; and

FIG. 4 is a partly enlarged, side elevational view of the electrical terminal taken along a direction Y shown in FIG. 1.

### DETAILED DESCRIPTION OF PREFERRED EMBODIMENTS

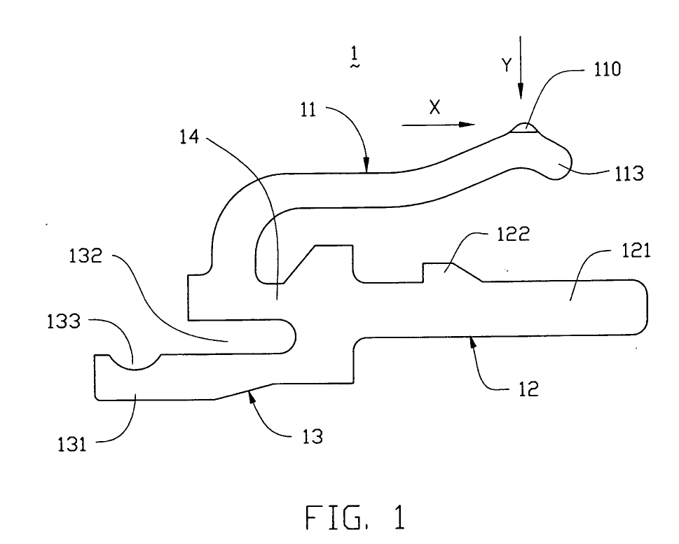

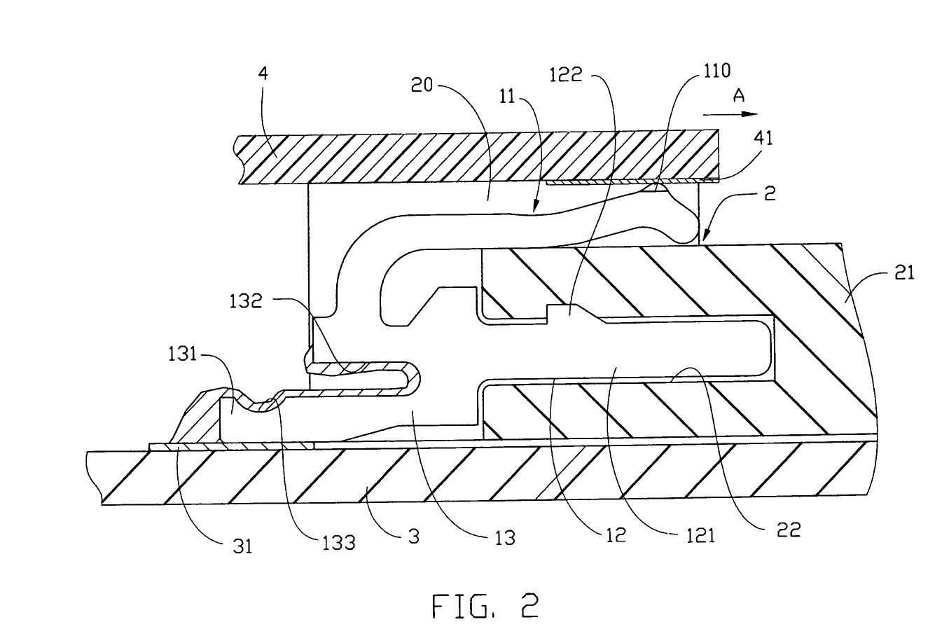

Referring to FIGS. 1 and 2, in this embodiment, an electrical terminal 1 in accordance with the present invention comprises a contacting portion 11, a soldering portion 13, a coupling portion 14 connecting the contacting portion 11 and the soldering portion 13, and a retaining portion 12 protruding from the coupling portion 14 and extending between the contacting portion 11 and the soldering portion 13. The contacting portion 11 defines a contacting point 110 adjacent to a tip end 113 thereof. The soldering portion 13 defines a soldering tail 131 extending in a direction opposite to an extending direction of the contacting portion 11. The tail 131 is surface mounted to a contact pad 31 formed on a printed circuit board (PCB). The retaining portion 12 is opposed to and parallel to the soldering portion 13. The retaining portion 12 similarly parallels the contacting portion 11 and has a protrusion beam 121 engaging with an insulating housing 21 of an electrical connector 2. The protrusion beam 121 forms a barb 122 on a top edge thereof for engaging with the housing 21 interferentially. A guiding slot 132 is defined between the soldering tail 131 and the contacting portion 11 opposite to the retaining portion 12. Furthermore, a cutout 133 is defined on an edge of the soldering tail 131 adjacent to the guiding slot 132.

Turning to FIG. 2, the contacting portion 11 of the terminal 1 is received in a passageway 20 defined in the housing 21 of the electrical connector 2. The protrusion beam 121 of the retaining portion 12 enters an engaging hole 22 defined in the housing 21. The barb 122 of the retaining portion 12 hooks the inner face of the engaging hole 22 so that the electrical terminal 1 is retained in the housing 21 firmly. After the connector 2 is mounted on a proper position on the PCB 3, the solder tail 131 is soldered to the contact pad 31 formed on the PCB 3. Then an electronic component 4 is inserted into the housing along a direction A. The mating portion 41 of the electronic component 4 can slip on the contacting point 110 of the electrical terminal 1 along the direction A.

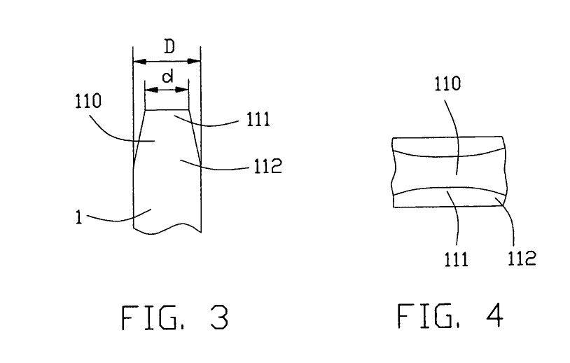

Together referring to FIGS. 3 and 4, the contacting point 110 includes an upper section 111 and a lower section 112. The width d of the upper section 111 is smaller than the width D of the lower section 112, which results in that the contacting point 110 is in a form of blade. When the mating portion 41 of the electronic component 4 slipping on the contacting point 110 along the direction A, the contacting point 110 can scraped the mating portion 41. If dielectric materials stain the mating portion 41, the contacting point 110 in the form of blade can scrap the dielectric material off the mating portion 41. In this condition, the electrical terminal 1 electrically connected with the corresponding electronic component 4 reliably.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrical terminal for being received in an insulating housing of an electrical connector, comprising:
a contacting portion defining a contacting point and a tip end, the contacting point including an upper section and a lower section wider than the upper section; and
a retaining portion retained in the insulating housing.

2. The electrical terminal as claimed in claim 1, wherein the contacting point is adjacent to the tip end of the electrical terminal.

3. The electrical terminal as claimed in claim 2, further comprising a soldering portion opposed to and parallel to the contacting portion and a coupling portion connecting the soldering portion and the contacting portion.

4. The electrical terminal as claimed in claim 3, wherein the retaining portion is between the contacting portion and the soldering portion and similarly parallels the contacting portion.

5. The electrical connector as claimed in claim 1, wherein the retaining portion forms a barb locking with the insulating housing.

6. An electrical connector for mating with an electronic component, comprising:
an insulating housing; and
a plurality of terminals received in the housing, each terminal comprising a contacting portion and a retaining portion engaging with the insulating housing interferentially, the contacting portion of the electrical terminal defining a contacting point and a tip end, the contacting point including an upper section and a lower section wider than the upper section.

7. The electrical connector as claimed in claim 6, wherein the contacting point is adjacent to the tip end of the electrical terminal

8. The electrical connector as claimed in claim 7, wherein the electrical terminal further comprises a soldering portion opposed to and parallel to the contacting portion and a coupling portion connecting the soldering portion and the contacting portion.

9. The electrical connector as claimed in claim 8, wherein the retaining portion is between the contacting portion and the soldering portion and similarly parallels the contacting portion.

10. An electrical connector assembly comprising:
a connector including:
an insulating housing; and
a plurality of terminals received in the housing, each terminal comprising a contacting portion and a retaining portion, the contacting portion of the electrical terminal defining a contacting point adjacent to a tip end, the contacting point including an upper section and a lower section wider than the upper section;
a daughter card inserted into the housing with conductive pads each engaged with the upper section of the contacting point of the corresponding terminal; wherein
said upper section scrapes the corresponding conductive pad efficiently.

11. The assembly as claimed in claim 10, wherein said contacting point is tapered essentially in a cross-sectional view.

12. The assembly as claimed in claim 11, wherein said contacting point is located at a specific position of the contacting portion without extending therealong.
